(19) United States
(12) Patent Application Publication
(10) Pub. No.: US 2026/0278274 A1
(43) Pub. Date: Sep. 17, 2026

(54) INFORMATION EXTRACTION, CONFERENCE OPINION EXTRACTION, AND INFORMATION EXTRACTION MODEL TRAINING METHOD

(71) Applicant: ALIBABA INNOVATION PRIVATE LIMITED, Singapore (SG)

(72) Inventors: Fubang ZHAO, Hangzhou, Zhejiang (CN); Shihang WANG, Hangzhou, Zhejiang (CN); Yangyang KANG, Hangzhou, Zhejiang (CN); Changlong SUN, Hangzhou, Zhejiang (CN)

(21) Appl. No.: 19/166,449

(22) PCT Filed: Mar. 29, 2024
(86) PCT No.: PCT/SG2024/050203

§ 371 Date: Sep. 17, 2025

(30) Foreign Application Priority Data
Apr. 19, 2023 (CN) 202310450979.1

(51) Int. Cl. G06F 40/284; G06F 16/334; G06F 40/226

(52) U.S. Cl. CPC G06F 40/284; G06F 16/334; G06F 40/226

(57) ABSTRACT

The present disclosure provides an information extraction method. The information extraction method includes that: an information extraction task is received, where the information extraction task includes a text to be extracted and initial prompt information; the information extraction task is parsed to determine at least two information extraction sub-tasks corresponding to the information extraction task; current prompt information corresponding to a current information extraction sub-task is determined based on the initial prompt information and an extraction result of a completed information extraction sub-task in the at least two information extraction sub-tasks; the text to be extracted and the current prompt information are inputted into an information extraction model to determine an extraction result corresponding to the current information extraction sub-task; and a target extraction result of the information extraction task is determined based on extraction results corresponding to the at least two information extraction sub-tasks.

### CROSS-REFERENCE TO RELATED APPLICATIONS

The present disclosure claims priority of Chinese Patent Application No. 202310450979.1, filed to China National Intellectual Property Administration on Apr. 19, 2023 and titled “INFORMATION EXTRACTION, CONFERENCE OPINION EXTRACTION, AND INFORMATION EXTRACTION MODEL TRAINING METHOD”, the content of which is hereby incorporated by reference in its entirety.

### TECHNICAL FIELD

Embodiments of the present disclosure relate to the field of computer technologies, and in particular, to an information extraction method.

### BACKGROUND OF THE INVENTION

With the development of computer technologies, text processing increasingly depends on the Internet. Text processing is a process for analysis, comprehension, and extraction and so on, which has been widely applied to various fields of people's daily life. Taking information extraction as an example, the information extraction refers to a text processing technology of extracting fact information such as an entity, a relationship, or an event of a specified type from a natural language text, and forming structured data for output.

Currently, the information extraction is usually performed in a machine reading comprehension (MRC) manner. However, for complex and diverse information extraction tasks, different machine learning models need to be used to implement information extraction, causing a large resource consumption in a model training process and a relatively long time consumption in an information extraction process. Therefore, an efficient and highly universal information extraction solution is urgently needed.

### SUMMARY OF THE INVENTION

In view of this, embodiments of the present disclose provide an information extraction method. At least one embodiment of the present disclosure relate to a conference opinion extraction method, an information extraction model training method, an information extraction apparatus, a conference opinion extraction apparatus, an information extraction model training apparatus, a computing device, a computer-readable storage medium, and a computer program, to solve technical defects in the related art.

According to a first aspect of the embodiments of the present disclosure, an information extraction method is provided, including the following step.

An information extraction task is received, where the information extraction task includes a text to be extracted and initial prompt information.

The information extraction task is parsed to determine at least two information extraction sub-tasks corresponding to the information extraction task.

Current prompt information corresponding to a current information extraction sub-task is determined based on the initial prompt information and an extraction result of a completed information extraction sub-task in the at least two information extraction sub-tasks.

The text to be extracted and the current prompt information are inputted into an information extraction model to determine an extraction result corresponding to the current information extraction sub-task.

A target extraction result of the information extraction task is determined based on extraction results corresponding to the at least two information extraction sub-tasks.

According to a second aspect of the embodiments of the present disclosure, a conference opinion extraction method is provided, including the following step.

An opinion extraction task is received, where the opinion extraction task includes a conference text to be extracted and initial prompt information.

The opinion extraction task is parsed to determine at least two opinion extraction sub-tasks corresponding to the opinion extraction task.

Current prompt information corresponding to a current opinion extraction sub-task is determined based on the initial prompt information and an extraction result of a completed opinion extraction sub-task.

The conference text to be extracted and the current prompt information are inputted into an information extraction model to determine an extraction result corresponding to the current opinion extraction sub-task.

A target extraction result of the opinion extraction task is determined based on extraction results corresponding to the opinion extraction sub-tasks.

According to a third aspect of the embodiments of the present disclosure, an information extraction model training method is provided, including the following step.

A sample set is obtained, where the sample set includes multiple sample texts, and the sample text carries an information extraction label and sample prompt information.

A first sample text is extracted from the multiple sample texts, where the first sample text is any one of the multiple sample texts.

The first sample text and first sample prompt information carried in the first sample are inputted into an initial information extraction model, to obtain a first predicted extraction result corresponding to the first sample text.

The first predicted extraction result is compared with a first information extraction label carried in the first sample text to calculate a loss value.

Model parameters of the initial information extraction model are adjusted based on the loss value, and the step of extracting the first sample text from the multiple sample texts until a preset stop condition is satisfied, to obtain model parameters of an information extraction model is returned to be performed.

The model parameters of the information extraction model are sent to a terminal side device.

According to a fourth aspect of the embodiments of the present disclosure, an information extraction method is provided, including the following step.

An information extraction request sent by a user is received, where the information extraction request includes an information extraction task, and the information extraction task includes a text to be extracted and initial prompt information.

The information extraction task is parsed to determine at least two information extraction sub-tasks corresponding to the information extraction task.

Current prompt information corresponding to a current information extraction sub-task is determined based on the initial prompt information and an extraction result of a completed information extraction sub-task in the at least two information extraction sub-tasks.

The text to be extracted and the current prompt information are inputted into an information extraction model to determine an extraction result corresponding to the current information extraction sub-task.

A target extraction result of the information extraction task is determined based on extraction results corresponding to the at least two information extraction sub-tasks.

The target extraction result of the information extraction task is sent to the user.

According to a fifth aspect of the embodiments of the present disclosure, an information extraction apparatus is provided, including:
a first receiving module, configured to receive an information extraction task, where the information extraction task includes a text to be extracted and initial prompt information;
a first parsing module, configured to: parse the information extraction task to determine at least two information extraction sub-tasks corresponding to the information extraction task;
a first determining module, configured to: determine, based on the initial prompt information and an extraction result of a completed information extraction sub-task in the at least two information extraction sub-tasks, current prompt information corresponding to a current information extraction sub-task;
a first input module, configured to: input the text to be extracted and the current prompt information into an information extraction model to determine an extraction result corresponding to the current information extraction sub-task; and a second determining module, configured to determine a target extraction result of the information extraction task based on extraction results corresponding to the at least two information extraction sub-tasks.

According to a sixth aspect of the embodiments of the present disclosure, a conference opinion extraction apparatus is provided, including:
a second receiving module, configured to receive an opinion extraction task, where the opinion extraction task includes a conference text to be extracted and initial prompt information;
a second parsing module, configured to: parse the opinion extraction task to determine at least two opinion extraction sub-tasks corresponding to the opinion extraction task;
a second determining module, configured to determine, based on the initial prompt information and an extraction result of a completed opinion extraction sub-task, current prompt information corresponding to a current opinion extraction sub-task;
a second input module, configured to: input the conference text to be extracted and the current prompt information into an information extraction model to determine an extraction result corresponding to the current opinion extraction sub-task; and
a third determining module, configured to determine a target extraction result of the opinion extraction task based on extraction results corresponding to the opinion extraction sub-tasks.

According to a seventh aspect of the embodiments of the present disclosure, an information extraction model training apparatus is provided, including:
an obtaining module, configured to obtain a sample set, where the sample set includes multiple sample texts, and each sample text carries an information extraction label and sample prompt information;
an extraction module, configured to extract a first sample text from the multiple sample texts, where the first sample text is any one of the plurality of sample texts;
a third input module, configured to input the first sample text and first sample prompt information carried in the first sample text into an initial information extraction model, to obtain a first predicted extraction result corresponding to the first sample text;
a calculation module, configured to: compare the first predicted extraction result with a first information extraction label carried in the first sample text to calculate a loss value;
an adjustment module, configured to: adjust model parameters of the initial information extraction model based on the loss value, and return to perform the step of extracting the first sample text from the plurality of sample texts until a preset stop condition is satisfied, to obtain model parameters of an information extraction model; and
a first sending module, configured to send the model parameters of the information extraction model to a terminal side device.

According to an eighth aspect of the embodiments of the present disclosure, an information extraction apparatus is provided, including:
a third receiving module, configured to receive an information extraction request sent by a user, where the information extraction request includes an information extraction task, and the information extraction task includes a text to be extracted and initial prompt information;
a third parsing module, configured to: parse the information extraction task to determine at least two information extraction sub-tasks corresponding to the information extraction task;
a fourth determining module, configured to: determine, based on the initial prompt information and an extraction result of a completed information extraction sub-task in the at least two information extraction sub-tasks, current prompt information corresponding to a current information extraction sub-task;
a fourth input module, configured to: input the text to be extracted and the current prompt information into an information extraction model to determine an extraction result corresponding to the current information extraction sub-task;
a fifth determining module, configured to determine a target extraction result of the information extraction task based on extraction results corresponding to the at least two information extraction sub-tasks; and
a second sending module, configured to send the target extraction result of the information extraction task to the user.

According to a ninth aspect of the embodiments of the present disclosure, a computing device is provided, including:
a memory and a processor;
where the memory is configured to store computer-executable instructions, the processor is configured to execute the computer-executable instructions, and when being executed by the processor, the computer-executable instructions implement steps of the method provided in the first aspect, or the second aspect, or the third aspect.

According to a tenth aspect in the embodiments of the present disclosure, a computer-readable storage medium is provided, storing computer-executable instructions, and when being executed by a processor, the instructions implement steps of the method provided in the first aspect, or the second aspect, or the third aspect.

According to an eleventh aspect of the embodiments of the present disclosure, a computer program is provided. When the computer program is executed in a computer, the computer is enabled to perform steps of the method provided in the first aspect, or the second aspect, or the third aspect.

Embodiments of the present disclosure provide the information extraction method, including that: the information extraction task is received, where the information extraction task includes the text to be extracted and the initial prompt information; the information extraction task is parsed to determine the at least two information extraction sub-tasks corresponding to the information extraction task; the current prompt information corresponding to the current information extraction sub-task is determined based on the initial prompt information and the extraction result of the completed information extraction sub-task in the at least two information extraction sub-tasks; the text to be extracted and the current prompt information are inputted into the information extraction model to determine the extraction result corresponding to the current information extraction sub-task; and the target extraction result of the information extraction task is determined based on the extraction results corresponding to the at least two information extraction sub-tasks. Through parsing the information extraction task, a complex information extraction task is converted into at least two simple information extraction sub-tasks, so that this solution can support the information extraction task of any information extraction sub-task combination, thereby improving universality of information extraction. In addition, the extraction results of the at least two information extraction sub-tasks are determined by using the information extraction model, so that multiple information extraction sub-tasks are completed by using one information extraction model, thereby improving information extraction efficiency.

### BRIEF DESCRIPTION OF DRAWINGS

FIG. 1 is an architectural diagram of an information extraction system according to some embodiments of the present disclosure.

FIG. 2 is a flowchart of an information extraction method according to some embodiments of the present disclosure.

FIG. 3 is a flowchart of a conference opinion extraction method according to some embodiments of the present disclosure.

FIG. 4 is a flowchart of an information extraction model training method according to some embodiments of the present disclosure.

FIG. 5 is a flowchart of another information extraction method according to some embodiments of the present disclosure.

FIG. 6 is a flowchart of a processing procedure of an information extraction method according to some embodiments of the present disclosure.

FIG. 7 is a flowchart of a processing procedure of another information extraction method according to some embodiments of the present disclosure.

FIG. 8 is an interface schematic diagram of an information extraction interface according to some embodiments of the present disclosure.

FIG. 9 is a structural schematic diagram of an information extraction apparatus according to some embodiments of the present disclosure.

FIG. 10 is a structural schematic diagram of a conference opinion extraction apparatus according to some embodiments of the present disclosure.

FIG. 11 is a structural schematic diagram of an information extraction model training apparatus according to some embodiments of the present disclosure.

FIG. 12 is a structural schematic diagram of another information extraction apparatus according to some embodiments of the present disclosure.

FIG. 13 is a structural schematic block diagram of a computing device according to some embodiments of the present disclosure.

### DETAILED DESCRIPTION OF THE INVENTION

In the following descriptions, many specific details are described for fully understanding of the present disclosure. However, the present disclosure is implemented in many other manners different from those described herein. A person having ordinary skill in the art may make similar promotion without departing from the connotation of this application. Therefore, the present disclosure is not limited to the specific embodiments disclosed below.

The terms used in at least one embodiment of the present disclosure are for the purpose of illustrating specific embodiments, and are not intended to limit the at least one embodiment of the present disclosure. The terms “a”, “said”, and “the” in a singular form used in at least one embodiment of the present disclosure and the appended claims are also intended to include a plural form, unless other meanings are clearly indicated in the context. It should be further understood that the term “and/or” as used in at least one embodiment of the present disclosure means including any or all possible combinations of at least one associated listed item.

It should be understood that although terms “first”, “second”, and the like is used for describing various information in at least one embodiment of the present disclosure, such information should not be limited to these terms. These terms are used to distinguish between information of the same type. For example, without departing from the scope of at least one embodiment of the present disclosure, “first” may also be referred to as “second”, and similarly, “second” is referred to as “first”. Depending on the context, for example, the word “if” used herein is interpreted as “while” or “when”, or “in response to determining”.

In addition, it should be noted that, user information (including but not limited to user equipment information, user personal information, and the like) and data (including but not limited to data for analysis, stored data, displayed data, and the like) in at least one embodiment of the present disclosure are all information and data that are authorized by a user or that are fully authorized by all parties, and related data needs to be collected, used, and processed by complying with relevant laws, regulations, and standards of relevant countries and regions. In addition, a corresponding operation entry is provided for the user to select to authorize or reject.

Terms in at least one embodiment of the present disclosure are first interpreted.

Universal information extraction (UIE): Extract, according to a particular extraction framework, an information structure (an entity, a relationship, an event, or the like) meeting an extraction requirement from a given group of free texts. For a same input text, different information structures are extracted by using different extraction frameworks.

Siamese neural network: The Siamese neural network may alternatively be referred to as a twin neural network, and is a coupled architecture established based on two artificial neural networks. The Siamese neural network uses two samples as inputs, and outputs a representation of a high-dimensional space in which the Siamese neural network is embedded, to compare similarity degrees between the two samples. Usually, the Siamese neural network is obtained by splicing two neural networks having a same structure and sharing weights.

BERT model: The BERT (Bidirectional Encoder Representation from Transformers) model is a pre-trained language representation model, and is used as an encoder for extracting features from an input text. The BERT model emphasizes that pre-training is no longer performed by using a conventional unidirectional language model or shallowly splicing two unidirectional language models as in the past, but a new masked language model is used, to generate deep bi-directional language representation.

A sequence to sequence (seq2seq) model: The sequence to sequence model is a network of an encoder-decoder structure, an input thereof is a sequence, and an output thereof is also a sequence. The encoder converts a signal sequence having a variable length into a vector having a fixed length for expression, and the decoder converts the vector having the fixed length into a target signal sequence having a variable length.

With the development of computer technologies, text processing increasingly depends on the Internet. Text processing is a process of text processing such as analysis, comprehension, and extraction, and has been widely applied to various fields of people's daily life. Using information extraction as an example, information extraction refers to a text processing technology of extracting fact information such as an entity, a relationship, or an event of a specified type from a natural language text, and forming structured data for output.

Currently, common information extraction solutions include the following two types. First, information extraction is performed in a machine reading comprehension (MRC)-based manner. However, inference time of a central processing unit (CPU) is long in the machine reading comprehension-based manner. Second, information extraction is performed based on seq2seq. However, performing information extraction based on seq2seq has a problem of poor information extraction efficiency. Therefore, an information extraction solution with high efficiency and high universality is urgently needed.

To solve the foregoing problem, in the embodiments of the present disclosure, based on a recursive reasoning design, a complex information extraction task is converted into several simple sub-tasks of extracting segments (span) based on prompt information and a text to be extracted. Specifically, the method includes that: the information extraction task is received, where the information extraction task includes the text to be extracted and the initial prompt information; the information extraction task is parsed to determine the at least two information extraction sub-tasks corresponding to the information extraction task; the current prompt information corresponding to the current information extraction sub-task is determined based on the initial prompt information and the extraction result of the completed information extraction sub-task in the at least two information extraction sub-tasks; the text to be extracted and the current prompt information are inputted into the information extraction model to determine the extraction result corresponding to the current information extraction sub-task; and the target extraction result of the information extraction task is determined based on the extraction results corresponding to the at least two information extraction sub-tasks. Through parsing the information extraction task, a complex information extraction task is converted into at least two simple information extraction sub-tasks, so that this solution can support the information extraction task of any information extraction sub-task combination, thereby improving universality of information extraction. In addition, the extraction results of the at least two information extraction sub-tasks are determined by using the information extraction model, so that multiple information extraction sub-tasks are completed by using one information extraction model, thereby improving information extraction efficiency.

In the present disclosure, an information extraction method is provided. The present disclosure also relates to a conference opinion extraction method, an information extraction model training method, an information extraction apparatus, a conference opinion extraction apparatus, an information extraction model training apparatus, a computing device, and a computer-readable storage medium, which are described one by one in the following embodiments.

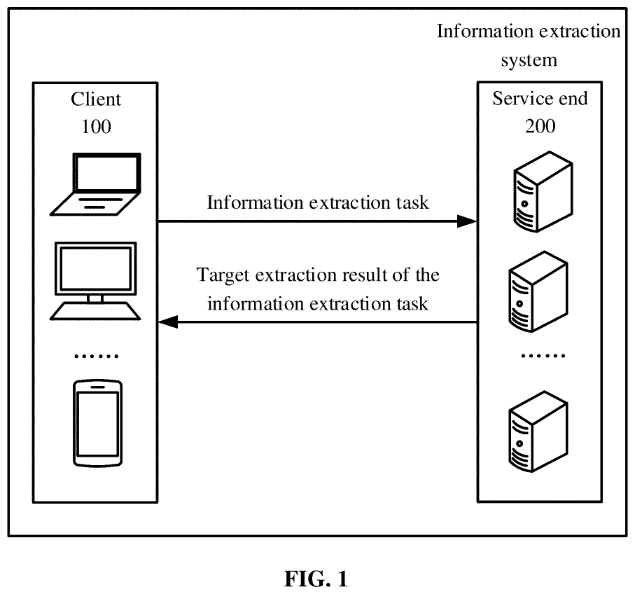

Referring to FIG. 1, FIG. 1 is an architectural diagram of an information extraction system according to some embodiments of the present disclosure. The information extraction system may include a client 100 and a service end 200.

The client 100 is configured to send an information extraction task to the service end 200, where the information extraction task includes a text to be extracted and initial prompt information.

The service end 200 is configured to: receive an information extraction task, where the information extraction task includes a text to be extracted and initial prompt information; parse the information extraction task to determine at least two information extraction sub-tasks corresponding to the information extraction task; determine, based on the initial prompt information and an extraction result of a completed information extraction sub-task in the at least two information extraction sub-tasks, current prompt information corresponding to a current information extraction sub-task; input the text to be extracted and the current prompt information into an information extraction model to determine an extraction result corresponding to the current information extraction sub-task; determine a target extraction result of the information extraction task based on extraction results corresponding to the at least two information extraction sub-tasks; and send the target extraction result of the information extraction task to the client 100.

The client 100 is further configured to receive the target extraction result of the information extraction task sent by the service end 200.

Through applying the solution in the embodiments of the present disclosure, the information extraction task is received, where the information extraction task includes the text to be extracted and the initial prompt information; the information extraction task is parsed to determine at least two information extraction sub-tasks corresponding to the information extraction task; the current prompt information corresponding to the current information extraction sub-task is determined based on the initial prompt information and the extraction result of the completed information extraction sub-task in the at least two information extraction sub-tasks; the text to be extracted and the current prompt information are inputted into the information extraction model to determine the extraction result corresponding to the current information extraction sub-task; and the target extraction result of the information extraction task is determined based on extraction results corresponding to the at least two information extraction sub-tasks. Through parsing the information extraction task, a complex information extraction task is converted into at least two simple information extraction sub-tasks, so that this solution can support an information extraction task of any information extraction sub-task combination, thereby improving universality of information extraction. In addition, the extraction results of the at least two information extraction sub-tasks are determined by using the information extraction model, so that multiple information extraction sub-tasks are completed by using one information extraction model, thereby improving information extraction efficiency.

In an actual application, the information extraction system includes multiple clients 100 and the service end 200. Communication connection is established between the multiple clients 100 by using the service end 200. In an information extraction scenario, the service end 200 is configured to provide an information extraction service between the multiple clients 100. The multiple clients 100 are respectively used as transmitting ends or receiving ends, and communication is implemented by using the service end 200.

A user may interact with the service end 200 by using the client 100 to receive data sent by another client 100, send data to another client 100, or the like. In an information extraction scenario, the user may publish a data stream to the service end 200 by using the client 100, and the service end 200 generates an extraction result based on the data stream and pushes the extraction result to another client that establishes communication with the client.

A connection is established between the client 100 and the service end 200 by using a network. The network provides a medium for a communication link between the client 100 and the service end 200. The network includes various connection types, for example, a wired communication link, a wireless communication link, or an optical cable. Data transmitted by the client 100 is published to the service end 200 after processing such as encoding, transcoding, and compression.

The client 100 is a browser, an APP (Application), or a web application such as an H5 (Hyper Text Markup Language 5) application, a light application (also referred to as an applet, a lightweight application), or a cloud application. The client 100 is obtained through development based on a software development kit (SDK), such as, a real-time communication (RTC) SDK, of a corresponding service provided by the service end 200. The client 100 is deployed in an electronic device, and needs to run depending on the device, some APPs in the device, or the like. For example, the electronic device has a display screen and support information browsing. For example, the electronic device is a terminal side device such as a personal mobile terminal such as a mobile phone, a tablet computer, or a personal computer. Generally, various other types of applications, such as a human-machine conversation application, a model training application, a text processing application, a web browser application, a shopping application, a search application, an instant messaging tool, an email client, and social platform software, may further be configured in the electronic device.

The service end 200 includes a server that provides various services, for example, a server that provides communication services for a plurality of clients; for another example, a server that provides support for a model used on a client and that is used for background training; and for another example, a server that processes data sent by a client. It should be noted that the service end 200 is implemented as a distributed server cluster including multiple servers, or is implemented as a single server. The server is further a server in a distributed system, or a server combined with blockchain. The server is alternatively a cloud server (cloud side device) that provides a cloud service, a cloud database, cloud computing, a cloud function, cloud storage, a network service, cloud communication, a middleware service, a domain name service, a security service, a content delivery network (CDN), big data, and a basic cloud computing service such as big data and an artificial intelligence platform, or is a smart cloud computing server or a smart cloud host with an artificial intelligence technology.

It should be noted that, the information extraction method provided in some embodiments of the present disclosure is usually performed by the service end. However, in other embodiments of the present disclosure, the client may also have a similar function to the service end, to perform the information extraction method provided in the present disclosure. In other embodiments, the information extraction method provided may alternatively be performed by the client and the service end jointly.

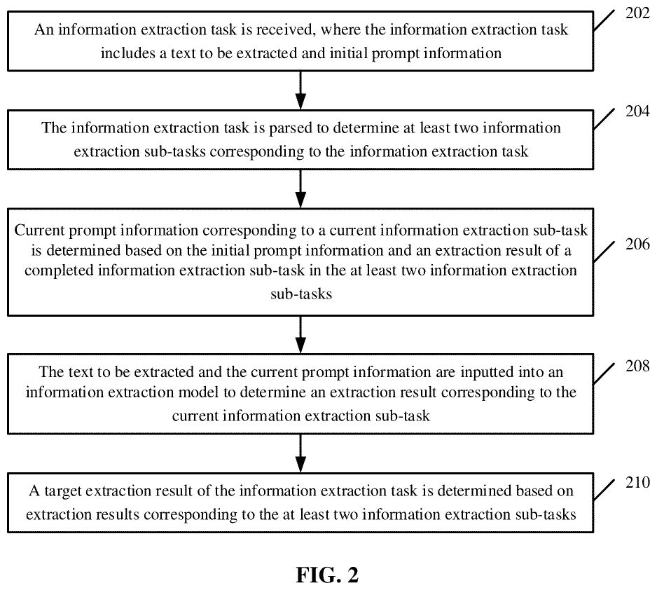

Referring to FIG. 2, FIG. 2 is a flowchart of an information extraction method according to some embodiments of the present disclosure. The method specifically includes the following steps.
In step 202, an information extraction task is received, where the information extraction task includes a text to be extracted and initial prompt information.

In at least one embodiment of the present disclosure, the information extraction task is processed based on the text to be extracted and the initial prompt information in the information extraction task, to implement information extraction.

Specifically, the information extraction task refers to a task of extracting information from the text to be extracted. There are multiple task types corresponding to the information extraction task. The task types include, but are not limited to, a named entity identification task, a relationship extraction task, an event extraction task, and an aspect sentiment extraction task. The task extraction tasks are tasks in different scenarios. The different scenarios include, but are not limited to, a financial scenario, a conference scenario, and an e-commerce scenario. The text to be extracted is an object of information extraction. The initial prompt information is information set to guide an information extraction process. The initial prompt information is understood as a schema. The schema is a general and abstract description of an object, reflects a cognition level of the object, and determines capability conversion of extracting an event by a machine.

It should be noted that the named entity identification task is a two-tuple task including an entity type and an entity span. The relationship extraction task is a triple task including a subject span, a relationship type, and an object span. The event extraction task is a four-tuple task including an event type, a trigger word span, an argument type, and an argument span. The aspect sentiment extraction task is a triple task including a theme, a sentiment span, and sentiment polarity.
In step 204, the information extraction task is parsed to determine at least two information extraction sub-tasks corresponding to the information extraction task.

In at least one embodiment of the present disclosure, after the information extraction task is received, the information extraction task is parsed to determine the at least two information extraction sub-tasks corresponding to the information extraction task.

In an actual application, there are multiple manners of parsing the information extraction task to determine the at least two information extraction sub-tasks corresponding to the information extraction task. Specifically, the manner is selected according to an actual situation, and this is not limited in the embodiments of the present disclosure.

In some embodiments of the present disclosure, the information extraction task is parsed to determine target information of the information extraction task, so that the at least two information extraction sub-tasks corresponding to the information extraction task are determined based on the target information.

For example, it is assumed that the information extraction task is extracting an entity and sentiment polarity in the text to be extracted. The information extraction task is parsed to determine the target information of the information extraction task to be “entity” and “sentiment polarity”. Then, the information extraction task is divided into two information extraction sub-tasks, and the two information extraction sub-tasks are respectively an “entity extraction task” and a “sentiment polarity identification task”.

In some embodiments of the present disclosure, the at least two information extraction sub-tasks corresponding to the information extraction task is determined based on a task type of the information extraction task. In other words, an operation of parsing the information extraction task to determine the at least two information extraction sub-tasks corresponding to the information extraction task includes the following steps.

A type of the information extraction task is identified to determine at least one task type corresponding to the information extraction task.

An information extraction object corresponding to each task type is obtained.

The at least two information extraction sub-tasks corresponding to the information extraction task are determined based on the initial prompt information and the information extraction object corresponding to each task type.

Specifically, information extraction objects corresponding to different types of information extraction tasks are different. For example, the information extraction objects corresponding to the named entity identification task include an entity type and an entity span; and the information extraction objects corresponding to the relationship extraction task is a subject span, a relationship type, and an object span.

In an actual application, there are multiple manners of performing type identification on the information extraction task, and determining the at least one task type corresponding to the information extraction task. Specifically, the manner is selected according to an actual situation, and this is not limited in the embodiments of the present disclosure. In some embodiments of the present disclosure, type identification is performed on the information extraction task by using a type identification model trained in advance, to determine the at least one task type corresponding to the information extraction task. In some embodiments of the present disclosure, a keyword corresponding to each task type is matched with the information extraction task, and a task type corresponding to the keyword matching the information extraction task is used as the at least one task type corresponding to the information extraction task.

Further, after the at least one task type corresponding to the information extraction task is determined, an information extraction object corresponding to each task type is obtained from a preset object library.

It should be noted that since the initial prompt information includes an extraction result of the information extraction object, when the at least two information extraction sub-tasks corresponding to the information extraction task are determined, a known extraction result in the initial prompt information is deleted from the information extraction object, and the at least two information extraction sub-tasks corresponding to the information extraction task are further determined based on an updated information extraction object.

For example, it is assumed that the task type corresponding to the information extraction task is the relationship extraction task, the initial prompt information includes a subject type and a relationship type, and information extraction objects corresponding to the relationship extraction task are obtained as “subject span, relationship type, and object span”. It can be learned based on the initial prompt information that the relationship type is known information, and unknown information in the relationship extraction task is “subject span and object span”. Therefore, the information extraction task is divided into two information extraction sub-tasks, and the two information extraction sub-tasks are respectively a “subject span extraction sub-task” and an “object span extraction sub-task”.

Through applying the solution in the embodiments of the present disclosure, type identification is performed on the information extraction task to determine the at least one task type corresponding to the information extraction task; the information extraction object corresponding to each task type is obtained; and the at least two information extraction sub-tasks corresponding to the information extraction task are determined based on the initial prompt information and the information extraction object corresponding to each task type. The information extraction task is accurately converted into at least two simple information extraction sub-tasks, so that this solution can support an information extraction task of any information extraction sub-task combination, thereby improving universality of information extraction.

In some optional embodiments of the present disclosure, after parsing the information extraction task, the method includes the following steps.

When the information extraction task does not include an information extraction sub-task, the text to be extracted and the initial prompt information are inputted into the information extraction model to determine the target extraction result of the information extraction task.

It should be noted that, when the information extraction task does not include the information extraction sub-task, the initial prompt information is prompt information corresponding to the information extraction task. The text to be extracted and the initial prompt information are directly inputted into the information extraction model, to determine the target extraction result of the information extraction task.

For example, it is assumed that the information extraction task is extracting the entity span from the text to be extracted, and the initial prompt information is the entity type from the text to be extracted, type identification is performed on the information extraction task, a task type corresponding to the information extraction task is determined to be a “named entity identification task”, and an information extraction object corresponding to the named entity identification task is obtained as “entity type and entity span”. It can be learned that the information extraction task is extracting the entity span, and does not include an information extraction sub-task. In this case, the text to be extracted and the initial prompt information is inputted into the information extraction model, to determine the target extraction result of the information extraction task.

Through applying the solution in the embodiments of the present disclosure, when the information extraction task does not include the information extraction sub-task, the text to be extracted and the initial prompt information are inputted into the information extraction model, to determine the target extraction result of the information extraction task, so that in this solution, the information extraction task including the sub-task can be processed, and the information extraction task not including the sub-task can also be processed, thereby improving an application scope of information extraction.
In step 206, current prompt information corresponding to a current information extraction sub-task is determined based on the initial prompt information and an extraction result of a completed information extraction sub-task in the at least two information extraction sub-tasks.

In at least one embodiment of the present disclosure, the information extraction task is received and parsed, and after the at least two information extraction sub-tasks corresponding to the information extraction task are determined, the current prompt information corresponding to the current information extraction sub-task is determined based on the initial prompt information and the extraction result of the completed information extraction sub-task in the at least two information extraction sub-tasks.

Specifically, the completed information extraction sub-task refers to a sub-task that is in the at least two information extraction sub-tasks and for which an extraction result has been obtained. The current information extraction sub-task refers to an information extraction sub-task, in a current information extraction process, for which information extraction is to be performed but an extraction result is not obtained yet.

For example, it is assumed that the information extraction task includes an information extraction sub-task A, an information extraction sub-task B, and an information extraction sub-task C, where the information extraction sub-task A is the completed information extraction sub-task, an extraction result of the information extraction sub-task A is a, and initial prompt information is Y. When the current information extraction sub-task is the information extraction sub-task B, it is determined based on the initial prompt information Y and the extraction result a that current prompt information of the information extraction sub-task B is Y+a.

It should be noted that, before the current prompt information corresponding to the current information extraction sub-task is determined based on the initial prompt information and the extraction result of the completed information extraction sub-task in the at least two information extraction sub-tasks, whether there is the completed information extraction sub-task is determined, and the current prompt information corresponding to the current information extraction sub-task is determined based on a determining result.

In some optional embodiments of the present disclosure, before determining, based on the initial prompt information and the extraction result of the completed information extraction sub-task in the at least two information extraction sub-tasks, the current prompt information corresponding to the current information extraction sub-task, the method further includes the following steps.

An extraction result corresponding to each information extraction sub-task is found to obtain a search result.

Whether there is the completed information extraction sub-task is determined based on the search result.

For example, it is assumed that the information extraction task includes the information extraction sub-task A, the information extraction sub-task B, and the information extraction sub-task C, where the information extraction sub-task A is the completed information extraction sub-task, the extraction result of the information extraction sub-task A is a, and the initial prompt information is Y. When the current information extraction sub-task is the information extraction sub-task B, it is determined based on the initial prompt information Y and the extraction result a that the current prompt information of the information extraction sub-task B is Y+a, and it is further determined that an extraction result corresponding to the information extraction sub-task B is b. When the current information extraction sub-task is the information extraction sub-task C, it is determined based on the initial prompt information Y, the extraction result a, and the extraction result b that current prompt information of the information extraction sub-task C is Y+a+b, and further, it is determined that an extraction result corresponding to the information extraction sub-task C is c.

Through applying the solution of the present disclosure, whether currently there is the completed information extraction sub-task is determined based on the search result generated by searching for the extraction result corresponding to each information extraction sub-task, and all information extraction sub-tasks are traversed completely, thereby ensuring accuracy of the completed information extraction sub-task, and further improving accuracy of the current prompt information.

In an actual application, whether there is the completed information extraction sub-task in the information extraction process is determined, and a determining result includes two types: existence and non-existence. Further, the current prompt information corresponding to the current information extraction sub-task is determined for different determining results. To be specific, an operation of determining, based on the initial prompt information and the extraction result of the completed information extraction sub-task in the at least two information extraction sub-tasks, the current prompt information corresponding to the current information extraction sub-task includes the following steps.

When there is no completed information extraction sub-task in the at least two information extraction sub-tasks, the initial prompt information is determined as the current prompt information corresponding to the current information extraction sub-task.

When there is the completed information extraction sub-task in the at least two information extraction sub-tasks, the current prompt information corresponding to the current information extraction sub-task is determined based on the initial prompt information and the extraction result of the completed information extraction sub-task.

It should be noted that, when no completed information extraction sub-task exists, it indicates that the current information extraction sub-task is the first sub-task for starting information extraction. In this case, the initial prompt information is directly determined as the current prompt information corresponding to the current information extraction sub-task. When there is the completed information extraction sub-task, it indicates that the current information extraction sub-task is not the first sub-task for starting information extraction, and the current prompt information corresponding to the current information extraction sub-task is affected by the extraction result of the completed information extraction sub-task. Therefore, the current prompt information corresponding to the current information extraction sub-task is determined based on the initial prompt information and the extraction result of the completed information extraction sub-task.

Further, when the current prompt information corresponding to the current information extraction sub-task is determined based on the initial prompt information and the extraction result of the completed information extraction sub-task, the initial prompt information and the extraction result of the completed information extraction sub-task are combined, to obtain the current prompt information.

Through applying the solution of the present disclosure, the current prompt information corresponding to the current information extraction sub-task is determined based on the determining result of whether there is the completed information extraction sub-task in a case-by-case recursive reasoning manner, thereby ensuring the accuracy of the current prompt information.

In some optional embodiments of the present disclosure, a case in which no completed information extraction sub-task exists in the at least two information extraction sub-tasks is used to further describe the foregoing process of determining the current prompt information corresponding to the current information extraction sub-task. To be specific, the at least two information extraction sub-tasks include a first information extraction sub-task; and an operation of determining, based on the initial prompt information and the extraction result of the completed information extraction sub-task in the at least two information extraction sub-tasks, the current prompt information corresponding to the current information extraction sub-task includes the following step.

The initial prompt information is determined as first prompt information corresponding to the first information extraction sub-task.

An operation of inputting the text to be extracted and the current prompt information into the information extraction model to determine the extraction result corresponding to the current information extraction sub-task includes the following step.

The text to be extracted and the first prompt information are inputted into the information extraction model to determine a first extraction result of the first information extraction sub-task.

Specifically, the first information extraction sub-task refers to an information extraction sub-task that is processed first in the at least two information extraction sub-tasks of the information extraction sub-task. When the first information extraction sub-task is a current processing sub-task, there is no completed information extraction sub-task in the at least two information extraction sub-tasks.

Further, the initial prompt information is directly determined as the first prompt information corresponding to the first information extraction sub-task, and the text to be extracted and the first prompt information are inputted into the information extraction model, to determine the first extraction result of the first information extraction sub-task.

It should be noted that, a processing procedure performed by the information extraction model on the text to be extracted and the first prompt information is the same as the process of “inputting the text to be extracted and the current prompt information into the information extraction model to determine the extraction result corresponding to the current information extraction sub-task”, and details are not described in the embodiments of the present disclosure again.

Through applying the solution in the embodiments of the present disclosure, the initial prompt information is determined as the first prompt information corresponding to the first information extraction sub-task, and the first extraction result of the first information extraction sub-task is determined by using the information extraction model, thereby improving information extraction efficiency and accuracy of the first extraction result.

Further, a case in which there is the completed information extraction sub-task in the at least two information extraction sub-tasks is used for further describing the foregoing process of determining the current prompt information corresponding to the current information extraction sub-task. It is assumed that the currently completed information extraction sub-task is the first information extraction sub-task, the extraction result corresponding to the currently completed information extraction sub-task is the first extraction result, and the at least two information extraction sub-tasks further include a second information extraction sub-task. After inputting the text to be extracted and the first prompt information into the information extraction model to determine the first extraction result of the first information extraction sub-task, the method further includes the following steps.

The first extraction result is determined as the extraction result of the completed information extraction sub-task, the second information extraction sub-task is determined as the current information extraction sub-task, the step of determining, based on the initial prompt information and the extraction result of the completed information extraction sub-task in the at least two information extraction sub-tasks, current prompt information corresponding to the current information extraction sub-task is returned to be performed, until there is no current information extraction sub-task to obtain the extraction results corresponding to the at least two information extraction sub-tasks.

Specifically, the second information extraction sub-task is a sub-task, in the at least two information extraction sub-tasks, that is after the completed first information extraction sub-task and for which information extraction is not performed. When the second information extraction sub-task is the current processing sub-task, there is a completed information extraction sub-task.

For example, it is assumed that the information extraction task includes the information extraction sub-task A and the information extraction sub-task B, where the first information extraction sub-task is the information extraction sub-task A, the extraction result of the information extraction sub-task A is a, and the initial prompt information is Y. The extraction result a is determined as the information extraction result of the completed information extraction sub-task, and the information extraction sub-task B is determined as the current information extraction sub-task. It is determined, based on the initial prompt information Y and the extraction result a, that the current prompt information of the information extraction sub-task B is Y+a. The text to be extracted and the current prompt information Y+a are inputted into the information extraction model to determine that an extraction result corresponding to the information extraction sub-task B is b. In this case, information extraction has been completed for both the information extraction sub-task A and the information extraction sub-task, to obtain the extraction result a corresponding to the information extraction sub-task A, and the extraction result b corresponding to the information extraction sub-task b.

Through applying the solution of the present disclosure, because in the information extraction process, the completed information extraction task is continuously updated, recursive reasoning is implemented when the current prompt information corresponding to the current information extraction sub-task is determined based on the initial prompt information and the extraction result of the completed information extraction sub-task, thereby converting a complex information extraction task into at least two simple information extraction sub-tasks, so that this solution can support an information extraction task of any information extraction sub-task combination, thereby improving universality of information extraction.
In step 208, the text to be extracted and the current prompt information are inputted into an information extraction model to determine an extraction result corresponding to the current information extraction sub-task.

In at least one embodiment of the present disclosure, the information extraction task is received; the information extraction task is parsed to determine at least two information extraction sub-tasks corresponding to the information extraction task; and after the current prompt information corresponding to the current information extraction sub-task is determined based on the initial prompt information and the extraction result of the completed information extraction sub-task in the at least two information extraction sub-tasks. Further, the text to be extracted and the current prompt information are inputted into an information extraction model, to determine the extraction result corresponding to the current information extraction sub-task.

Specifically, the extraction result is a text segment corresponding to the information extraction sub-task in the text to be extracted. The information extraction model is obtained through training based on multiple sample texts, and an information extraction label and sample prompt information carried in each sample text. The sample prompt information is obtained through analysis of a sample extraction task corresponding to the sample text. The information extraction model is a machine learning model. The machine learning model is understood as a trained program that can discover a pattern in new data and perform prediction. These models are represented as a mathematical function, which accepts a request in a form of input data, predicts the input data, and then provides an output as a response.

For example, when the text to be extracted is “Zhang San is a good guy”, the information extraction sub-task is extracting an entity segment in the text to be extracted, and the current prompt information is “person”, the text to be extracted and the current prompt information are inputted into the information extraction model, to obtain an extraction result of “Zhang San”.

In some optional embodiments of the present disclosure, the information extraction model includes a feature extraction layer, an attention layer, and an output layer, and the feature extraction layer includes a first feature extraction layer and a second feature extraction layer and the first feature extraction layer is coupled with the second feature extraction layer. An operation of inputting the text to be extracted and the current prompt information into the information extraction model to determine the extraction result corresponding to the current information extraction sub-task includes the following steps.

The text to be extracted is inputted into the first feature extraction layer, to obtain a text feature of the text to be extracted.

The current prompt information is inputted into the second feature extraction layer, to obtain a prompt feature of the current prompt information.

The text feature and the prompt feature are inputted into the attention layer, to obtain an attention feature.

The attention feature is inputted into the output layer, to obtain the extraction result corresponding to the current information extraction sub-task.

Specifically, the feature extraction layer is configured to generate embedded high-dimensional space representations, to be specific, a text feature and a prompt feature, of the inputted information. The text feature may also be referred to as a text vector, and the prompt feature may also be referred to as a prompt vector. Siamese neural networks with the same structure and a shared weight are set in the first feature extraction layer and the second feature extraction layer and the first feature extraction layer is coupled with the second feature extraction layer in the feature extraction layer, to ensure consistency of text feature and prompt feature dimensions. The feature extraction layer includes, but is not limited to, a recurrent neural network (RNN), a convolutional neural network (CNN), and the like. Specifically, the feature extraction layer is selected according to an actual situation, and is not limited in the present disclosure.

After the text feature of the text to be extracted and the prompt feature of the current prompt information are obtained, the text feature and the prompt feature are inputted into the attention layer. The attention layer herein is a cross-attention layer. The cross-attention layer asymmetrically combines two embedded sequences (the text feature and the prompt feature) in the same dimension, where one sequence is inputted as query, and the other sequence is inputted as key and value, to obtain the attention feature. Further, the attention feature is inputted to the output layer, to obtain the extraction result corresponding to the current information extraction sub-task.

Through applying the solution in the embodiments of the present disclosure, the text to be extracted is inputted into the first feature extraction layer, to obtain the text feature of the text to be extracted; the current prompt information is inputted into the second feature extraction layer, to obtain the prompt feature of the current prompt information; the text feature and the prompt feature are inputted into the attention layer, to obtain the attention feature; and the attention feature is inputted to the output layer, to obtain the extraction result corresponding to the current information extraction sub-task, thereby ensuring accuracy of the extraction result.

In some optional embodiments of the present disclosure, since the feature extraction layer includes the first feature extraction layer and the second feature extraction layer and the first feature extraction layer is coupled with the second feature extraction layer, the first feature extraction layer is configured to extract the text feature of the text to be extracted, and the second feature extraction layer is configured to extract the prompt feature of the current prompt information. In the processing process of the at least two information extraction sub-tasks, the text to be extracted remains unchanged. Therefore, the information extraction process is accelerated by using the first feature extraction layer to perform feature extraction on the text to be extracted once, and buffering the text feature for repeated use. In other words, an operation of inputting the text to be extracted into the first feature extraction layer, to obtain the text feature of the text to be extracted includes the following steps.

When the text feature of the text to be extracted is not buffered in the information extraction model, the text to be extracted is inputted into the first feature extraction layer, to obtain the text feature of the text to be extracted, and the text feature in the information extraction model is buffered.

When the text feature of the text to be extracted is buffered in the information extraction model, the text feature buffered in advance is obtained.

It should be noted that, when the text to be extracted is inputted into the first feature extraction layer to obtain the text feature of the text to be extracted, whether the text feature of the text to be extracted is buffered in the information extraction model is determined. When the text feature of the text to be extracted is not buffered, it indicates that the first feature extraction layer processes the text to be extracted for the first time. The text to be extracted is inputted into the first feature extraction layer, to obtain the text feature of the text to be extracted. After the text feature of the text to be extracted are obtained, the text feature is buffered in the information extraction model, and the text feature of the text to be processed are directly obtained from a buffer during subsequent processing. When the text feature is buffered, the text feature of the text to be extracted is directly obtained from the buffer without performing feature extraction on the text to be processed by using the first feature extraction layer, thereby accelerating the information extraction process.

Through applying the solution in the embodiments of the present disclosure, the feature extraction layer of the information extraction model is set in a form of Siamese neural network, to buffer the text feature of the text to be processed, thereby avoiding repeated extraction by using the information extraction model, and improving information extraction efficiency.

In some optional embodiments of the present disclosure, the output layer is a pointer network. The pointer network is configured to generate a series of pointers pointing to input sequence elements, to identify start and end positions of a segment that needs to be extracted. An operation of inputting the attention feature to the output layer, to obtain the extraction result corresponding to the current information extraction sub-task includes the following steps.

The attention feature to the output layer is inputted to determine a start pointer sequence and an end pointer sequence.

The extraction result corresponding to the current information extraction sub-task is extracted from the text to be extracted and outputted based on the start pointer sequence and the end pointer sequence.

Specifically, the start pointer sequence and the end pointer sequence is a sequence “01”, where “1” in the sequence “01” indicates the extraction result. Position information of the extraction result in the text to be extracted is determined based on “1” in the start pointer sequence and “1” in the end pointer sequence. Further, the extraction result corresponding to the current information extraction sub-task is obtained based on the position information and the text to be extracted.

For example, it is assumed that the text to be extracted is “Zhang San is a good guy”, the start pointer sequence is [1 0 0 0 0], the end pointer sequence is [0 1 0 0 0], “1” in the start pointer sequence indicates a start position of the extraction result, and “1” in the end pointer sequence indicates an end position of the extraction result. Therefore, an extraction result “Zhang San” corresponding to the current information extraction sub-task is extracted from the text to be extracted and outputted based on the start pointer sequence and the end pointer sequence.

Through applying the solution in the embodiments of the present disclosure, the attention feature is inputted to the output layer, and the start pointer sequence and the end pointer sequence are determined; and the extraction result corresponding to the current information extraction sub-task are extracted from the text to be extracted and outputted based on the start pointer sequence and the end pointer sequence, thereby improving accuracy of the extraction result.
In step 210, a target extraction result of the information extraction task is determined based on extraction results corresponding to the at least two information extraction sub-tasks.

In at least one embodiment of the present disclosure, the information extraction task is received; the information extraction task is parsed to determine at least two information extraction sub-tasks corresponding to the information extraction task; the current prompt information corresponding to the current information extraction sub-task is determined based on the initial prompt information and an extraction result of the completed information extraction sub-task in the at least two information extraction sub-tasks; the text to be extracted and the current prompt information are inputted into the information extraction model; and after the extraction result corresponding to the current information extraction sub-task is determined, the target extraction result of the information extraction task is determined based on extraction results corresponding to the at least two information extraction sub-tasks.

It should be noted that, after the extraction results corresponding to the at least two information extraction sub-tasks are obtained, the extraction results corresponding to the at least two information extraction sub-tasks are integrated, and the integrated extraction results are determined as the target extraction result.

Through applying the solution in the embodiments of the present disclosure, by parsing the information extraction task, a complex information extraction task is converted into at least two simple information extraction sub-tasks, so that this solution can support an information extraction task of any information extraction sub-task combination, thereby improving universality of information extraction. In addition, the extraction results of the at least two information extraction sub-tasks are determined by using the information extraction model, so that multiple information extraction sub-tasks are completed by using one information extraction model, thereby improving information extraction efficiency.

In some optional embodiments of the present disclosure, the information extraction model training method includes the following steps.

A sample set is obtained, where the sample set includes multiple sample texts, and each sample text carries an information extraction label and sample prompt information;

A first sample text is extracted from the multiple sample texts, where the first sample text is any one of the multiple sample texts.

The first sample text and first sample prompt information carried in the first sample are inputted into an initial information extraction model, to obtain a first predicted extraction result corresponding to the first sample text.

The first predicted extraction result is compared with a first information extraction label carried in the first sample text to calculate a loss value.

Model parameters of the initial information extraction model are adjusted based on the loss value, and the step of extracting the first sample text from the multiple sample texts is returned to be performed until a preset stop condition is satisfied, to obtain the information extraction model.

Specifically, a training manner of the information extraction model is supervised training. To be specific, each sample text in the sample set carries a real information extraction label, where the information extraction label is an extraction target of the information extraction model, and is configured for guiding a training process of the information extraction model. A manner of obtaining the sample set is reading, from another data obtaining device or database, a large quantity of sample texts carrying information extraction labels and sample prompt information to form the sample set. Alternatively, a large quantity of sample texts carrying information extraction labels and sample prompt information that are inputted by a user are received to form the sample set. The manner of obtaining the text training set is specifically selected according to an actual situation, and this is not limited in the embodiments of the present disclosure.

It should be noted that, an implementation of the “inputting the first sample text and the first sample prompt information carried in the first sample into the initial information extraction model, to obtain the first predicted extraction result corresponding to the first sample text” is the same as the foregoing implementation of the “inputting the text to be extracted and the current prompt information into the information extraction model to determine the extraction result corresponding to the current information extraction sub-task”, and details are not described again in the embodiments of the present disclosure.

In some embodiments of this disclosure, the preset stop condition includes that the loss value is less than or equal to a preset threshold. After the loss value is calculated based on the first predicted extraction result and the first information extraction label carried in the first sample text, the loss value is compared with the preset threshold.

Specifically, when the loss value is greater than the preset threshold, it indicates that a difference between the first predicted extraction result and the first information extraction label carried in the first sample text is large, and a prediction capability of the initial information extraction model for the first sample text is poor. In this case, the model parameters of the initial information extraction model are adjusted, and the step of extracting the first sample text from the multiple sample texts is performed again. The initial information extraction model continues to be trained until the loss value is less than or equal to the preset threshold, which indicates that the difference between the first predicted extraction result and the first information extraction label carried in the first sample text is small. Then the preset stop condition is reached, and the trained information extraction model is obtained.

In some embodiments of the present disclosure, in addition to comparing a magnitude relationship between the loss value and the preset threshold, whether training on the current initial information extraction model is completed is further determined with reference to a quantity of iterations.

Specifically, when the loss value is greater than the preset threshold, the model parameters of the initial information extraction model is adjusted, and the step of extracting the first sample text from the multiple sample texts is performed again. The initial information extraction model continues to be trained until a preset quantity of iterations is reached. Then iteration is stopped, to obtain the trained information extraction model. The preset threshold and the preset quantity of iterations are specifically selected according to an actual situation, and are not limited in the embodiments of the present disclosure.

In an actual application, there are many functions for calculating the loss value, for example, a circle loss. Specifically, the function is selected according to an actual situation. This is not limited in the embodiments of the present disclosure. Calculation objects of the circle loss are the first predicted extraction result outputted by the model and the first information extraction label carried in the first sample text.

Through applying the solution in the embodiments of the present disclosure, the loss value is obtained through calculation based on the first predicted extraction result and the first information extraction label carried in the first sample text, the loss value is compared with the preset stop condition, and the initial information extraction model continues to be trained when the preset stop condition is not satisfied, until the preset stop condition is satisfied, to complete training and obtain the information extraction model. The model parameters of the initial information extraction model are continuously adjusted, so that the finally obtained information extraction model can be more accurate.

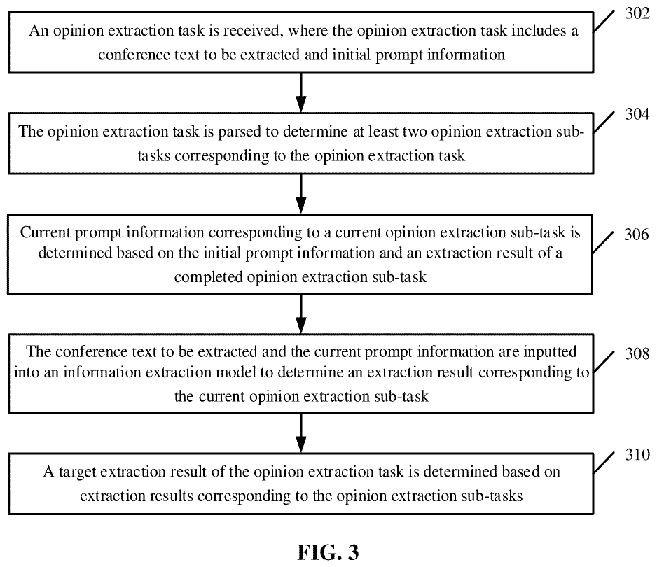

Referring to FIG. 3, FIG. 3 is a flowchart of a conference opinion extraction method according to some embodiments of the present disclosure. The method specifically includes the following steps.
In step 302, an opinion extraction task is received, where the opinion extraction task includes a conference text to be extracted and initial prompt information.
In step 304, the opinion extraction task is parsed to determine at least two opinion extraction sub-tasks corresponding to the opinion extraction task.
In step 306, current prompt information corresponding to a current opinion extraction sub-task is determined based on the initial prompt information and an extraction result of a completed opinion extraction sub-task.
In step 308, the conference text to be extracted and the current prompt information are inputted into an information extraction model to determine an extraction result corresponding to the current opinion extraction sub-task.
In step 310, a target extraction result of the opinion extraction task is determined based on extraction results corresponding to the opinion extraction sub-tasks.

It should be noted that, implementations of step 302 to step 310 are the same as implementations of step 202 to step 210, and are not described again in the embodiments of the present disclosure.

For example, assuming that the opinion extraction task is extracting a person and sentiment polarity information in the conference text to be extracted “Hereby commend Zhang San, who performs well in this job, for encouragement”, the target extraction result “Zhang San, well” is determined by using the foregoing conference opinion extraction method.

Through applying the solution in the embodiments of the present disclosure, by parsing the opinion extraction task, a complex opinion extraction task is converted into at least two simple opinion extraction sub-tasks, so that this solution can support an opinion extraction task of any opinion extraction sub-task combination, thereby improving universality of opinion extraction. In addition, the extraction results of the opinion extraction sub-tasks are determined by using the information extraction model, so that multiple opinion extraction sub-tasks are completed by using one information extraction model, thereby improving conference opinion extraction efficiency.

Referring to FIG. 4, FIG. 4 is a flowchart of an information extraction model training method according to some embodiments of the present disclosure. The information extraction model training method is applied to a cloud side device, and specifically includes the following steps.
In step 402, a sample set is obtained, where the sample set includes multiple sample texts, and each sample text carries an information extraction label and sample prompt information.
In step 404, a first sample text is extracted from the multiple sample texts, where the first sample text is any one of the multiple sample texts.
In step 406, the first sample text and first sample prompt information carried in the first sample text are inputted into an initial information extraction model, to obtain a first predicted extraction result corresponding to the first sample text.
In step 408, the first predicted extraction result is compared with a first information extraction label carried in the first sample text to calculate a loss value.
In step 410, model parameters of the initial information extraction model are adjusted based on the loss value, and the step of extracting a first sample text from the multiple sample texts is returned to be performed until a preset stop condition is satisfied, to obtain model parameters of an information extraction model.
In step 412, the model parameters of the information extraction model are sent to a terminal side device.

It should be noted that, implementations of step 402 to step 410 are the same as implementations of step 202 to step 210, and are not described again in the embodiments of the present disclosure.

In an actual application, after the cloud side device sends the model parameters of the information extraction model to the terminal side device, the terminal side device may locally build the information extraction model based on the model parameters of the information extraction model, and further perform information extraction by using the information extraction model.

Through applying the solution in the embodiments of the present disclosure, the loss value is obtained through calculation based on the first predicted extraction result and the first information extraction label carried in the first sample text, the loss value is compared with the preset stop condition, and the initial information extraction model continues to be trained when the preset stop condition is not satisfied, until the preset stop condition is satisfied, to complete training and obtain the information extraction model. The model parameters of the initial information extraction model are continuously adjusted, so that the finally obtained information extraction model can be more accurate.

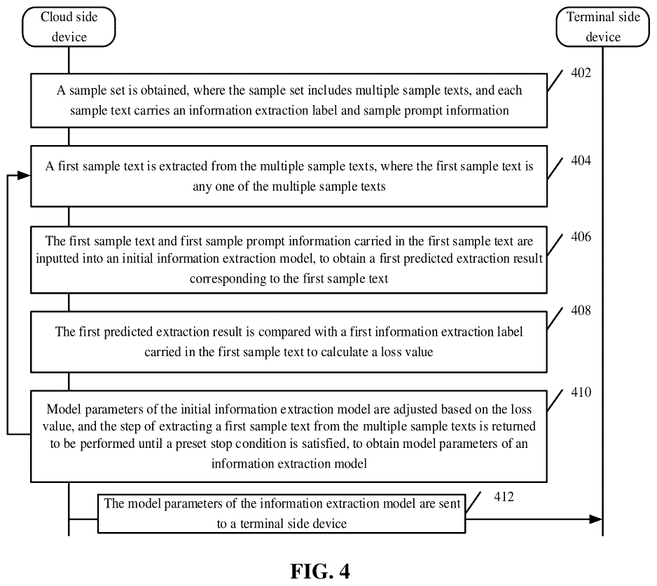

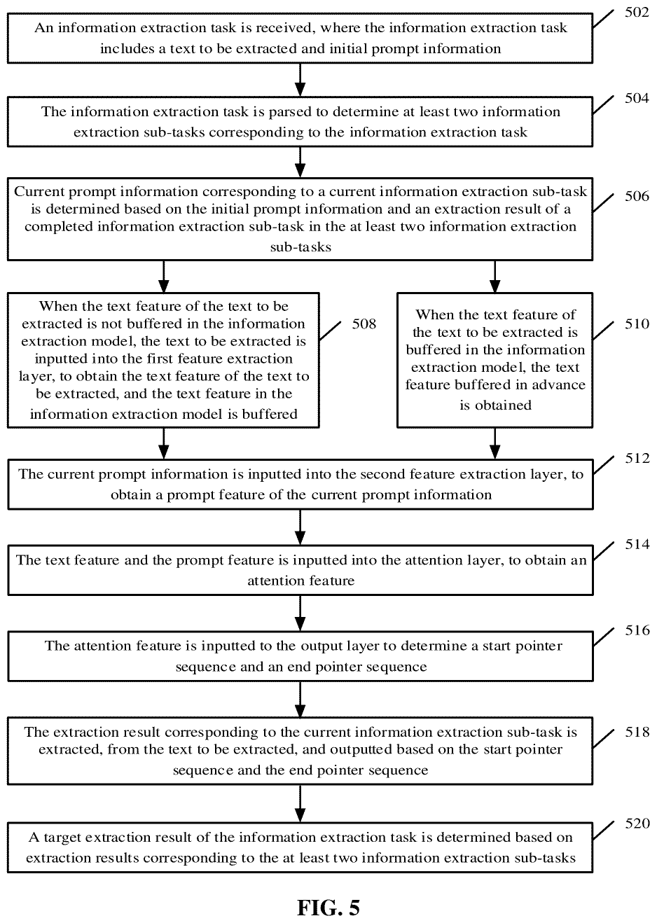

Referring to FIG. 5, FIG. 5 is a flowchart of another information extraction method according to some embodiments of the present disclosure.
In step 502, an information extraction task is received, where the information extraction task includes a text to be extracted and initial prompt information.
In step 504, the information extraction task is parsed to determine at least two information extraction sub-tasks corresponding to the information extraction task.
In step 506, current prompt information corresponding to a current information extraction sub-task is determined based on the initial prompt information and an extraction result of a completed information extraction sub-task in the at least two information extraction sub-tasks.
In step 508, when the text feature of the text to be extracted is not buffered in the information extraction model, the text to be extracted is inputted into the first feature extraction layer, to obtain the text feature of the text to be extracted, and the text feature in the information extraction model is buffered.
In step 510, when the text feature of the text to be extracted is buffered in the information extraction model, the text feature buffered in advance is obtained.
In step 512, the current prompt information is inputted into the second feature extraction layer, to obtain a prompt feature of the current prompt information.
In step 514, the text feature and the prompt feature is inputted into the attention layer, to obtain an attention feature.
In step 516, the attention feature is inputted to the output layer to determine a start pointer sequence and an end pointer sequence.
In step 518, the extraction result corresponding to the current information extraction sub-task is extracted, from the text to be extracted, and outputted based on the start pointer sequence and the end pointer sequence.
In step 520, a target extraction result of the information extraction task is determined based on extraction results corresponding to the at least two information extraction sub-tasks.

It should be noted that, specific implementations of step 502 to step 520 are the same as the implementation of the information extraction method provided in FIG. 2, and are not described again in the embodiments of the present disclosure.

Through applying the solution in the embodiments of the present disclosure, by parsing the information extraction task, a complex information extraction task is converted into at least two simple information extraction sub-tasks, so that this solution can support an information extraction task of any information extraction sub-task combination, thereby improving universality of information extraction. In addition, the feature extraction layer of the information extraction model is set in a form of Siamese neural network, to buffer the text feature of the text to be processed, thereby avoiding repeated extraction by using the information extraction model, and improving information extraction efficiency.

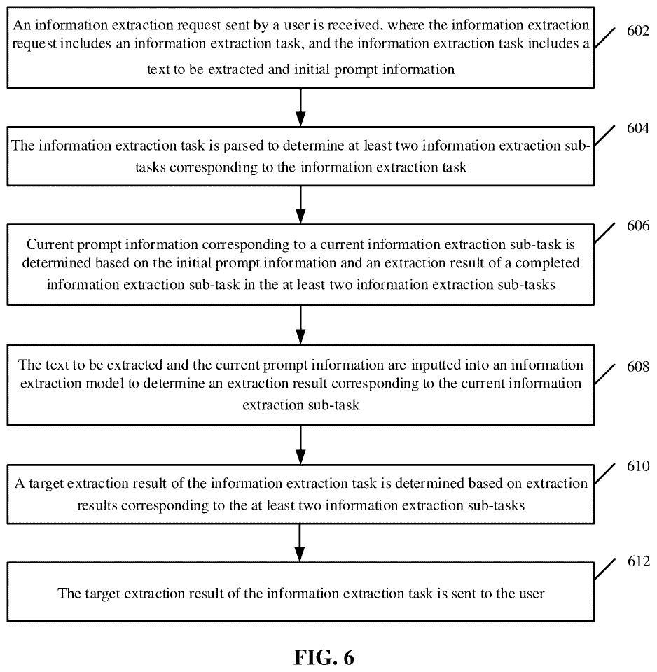

Referring to FIG. 6, FIG. 6 is a flowchart of a processing procedure of an information extraction method according to some embodiments of the present disclosure. The method specifically includes the following steps.
In step 602, an information extraction request sent by a user is received, where the information extraction request includes an information extraction task, and the information extraction task includes a text to be extracted and initial prompt information.
In step 604, the information extraction task is parsed to determine at least two information extraction sub-tasks corresponding to the information extraction task.
In step 606, current prompt information corresponding to a current information extraction sub-task is determined based on the initial prompt information and an extraction result of a completed information extraction sub-task in the at least two information extraction sub-tasks.
In step 608, the text to be extracted and the current prompt information are inputted into an information extraction model to determine an extraction result corresponding to the current information extraction sub-task.
In step 610, a target extraction result of the information extraction task is determined based on extraction results corresponding to the at least two information extraction sub-tasks.
In step 612, the target extraction result of the information extraction task is sent to the user.

It should be noted that, implementations of step 602 to step 610 are the same as implementations of step 202 to step 210, and are not described again in the embodiments of the present disclosure.

Through applying the solution in the embodiments of the present disclosure, by parsing the information extraction task, a complex information extraction task is converted into at least two simple information extraction sub-tasks, so that this solution can support an information extraction task of any information extraction sub-task combination, thereby improving universality of information extraction. In addition, the extraction results of the at least two information extraction sub-tasks are determined by using the information extraction model, so that multiple information extraction sub-tasks are completed by using one information extraction model, thereby improving information extraction efficiency. The target extraction result of the information extraction task is sent to the user, thereby improving user experience.

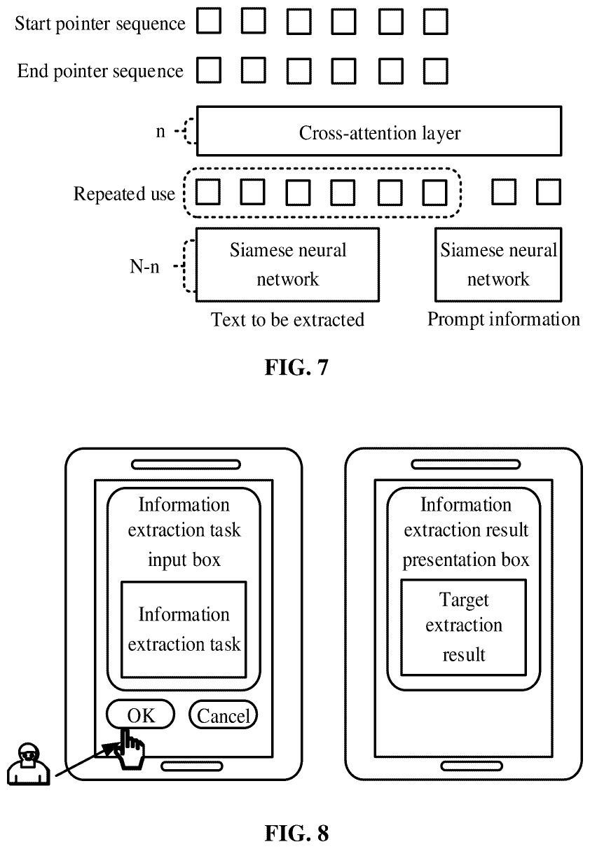

Referring to FIG. 7, FIG. 7 is a flowchart of a processing procedure of another information extraction method according to some embodiments of the present disclosure. As shown in FIG. 7, model parameters of an information extraction model are initialized by using a pre-trained model (for example, a BERT model). First N-n layers of the information extraction model are a Siamese neural network, that is, a feature extraction layer of the information extraction model. The feature extraction layer includes a first feature extraction layer and a second feature extraction layer and the first feature extraction layer is coupled with the second feature extraction layer. The first feature extraction layer is configured to extract a text feature from a text to be extracted, and the second feature extraction layer is configured to extract a prompt feature from prompt information. The last n layers of the information extraction model are used as a uniflow cross-text cross-attention layer. An output layer includes a pointer network, and an attention feature outputted by an attention layer is inputted to the output layer. In the output layer, a start pointer sequence and an end pointer sequence are determined, and an extraction result corresponding to a current information extraction sub-task is extracted from the text to be extracted and outputted based on the start pointer sequence and the end pointer sequence.

It should be noted that for a text to be extracted, a hidden vector (hidden states) outputted by the first N-n layers of the text to be extracted remains unchanged, and is buffered for repeated use during reasoning, thereby implementing acceleration of information extraction. In comparison with a conventional solution, information extraction efficiency in this solution can be improved by 30%, and an information extraction effect in a low resource scenario can be improved by 7%.

In an actual application, a complex information extraction task is converted into several sub-tasks performed recursively, of extracting corresponding extraction results based on prompt information (Prompt).

For example, for a named entity identification task, because the named entity identification task includes an entity type and an entity span, a text to be processed and the entity type are inputted into the information extraction model, to obtain an entity segment.

For a relationship extraction task, since the relationship extraction task includes a subject span, a relationship type, and an object span, the relationship extraction task is divided into two information extraction sub-tasks (Span Extraction) of enumerating and input. Information extraction sub-task 1: Input the text to be processed and a subject type into the information extraction model, to obtain a subject segment. Information extraction sub-task 2: Input the text to be processed, the relationship type, and the subject segment into the information extraction model, to obtain an object segment.

For an event extraction task, since the event extraction task includes an event type, an argument role, and an argument segment, the event extraction task is divided into two information extraction sub-tasks. Information extraction sub-task 1: Input the text to be processed and the event type into the information extraction model, to obtain a trigger word segment. Information extraction sub-task 2: Input the text to be processed, the event type, and the trigger word segment into the information extraction model, to obtain the argument segment.

Through applying the solution in the embodiments of the present disclosure, by using recursive push design, a complex information extraction task is converted into several simple sub-tasks of extracting segments based on prompt information and texts, thereby supporting extraction of any tuple set. In addition, in the information extraction model, a text hidden vector is buffered by using the Siamese neural network, thereby avoiding repeated calculation, improving information extraction efficiency, and implementing general information extraction.

Referring to FIG. 8, FIG. 8 is an interface schematic diagram of an information extraction interface according to some embodiments of the present disclosure. The information extraction interface includes an information extraction task input interface and an information extraction result presentation interface. The information extraction task input interface includes an information extraction task input box, an “OK” control, and a “Cancel” control. The information extraction result presentation interface includes an information extraction result presentation box.

A user inputs an information extraction task by using the information extraction task input box displayed by a client, where the information extraction task includes a text to be extracted and initial prompt information. The user selects the “OK” control. The service end receives the information extraction task sent by the client, parses the information extraction task to determine at least two information extraction sub-tasks corresponding to the information extraction task, determines, based on the initial prompt information and an extraction result of a completed information extraction sub-task in the at least two information extraction sub-tasks, current prompt information corresponding to a current information extraction sub-task, inputs the text to be extracted and the current prompt information into an information extraction model to determine an extraction result corresponding to the current information extraction sub-task, determines a target extraction result of the information extraction task based on extraction results corresponding to the at least two information extraction sub-tasks, and sends the target extraction result to the client. The client displays the target extraction result in the information extraction result presentation box.

In an actual application, a manner in which the user operates on the control includes any manner such as clicking, double-clicking, touching, mouse hovering, sliding, holding, voice control, or shaking, and is specifically selected according to an actual situation. This is not limited in the embodiments of the present disclosure.

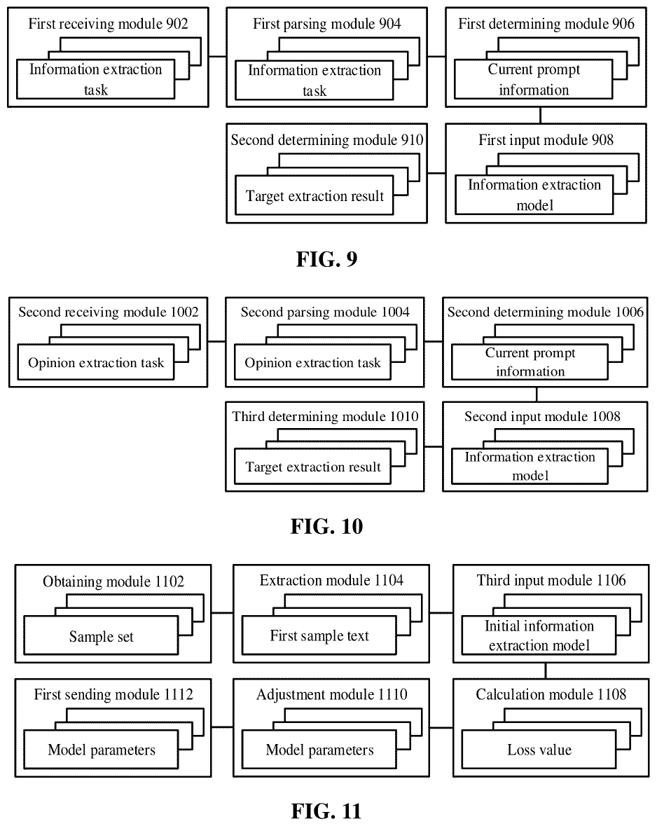

Corresponding to the foregoing method embodiment, the present disclosure further provides some embodiments of an information extraction apparatus. FIG. 9 is a structural schematic diagram of an information extraction apparatus according to some embodiments of the present disclosure. As shown in FIG. 9, the apparatus includes:
a first receiving module 902, configured to receive an information extraction task, where the information extraction task includes a text to be extracted and initial prompt information;
a first parsing module 904, configured to: parse the information extraction task to determine at least two information extraction sub-tasks corresponding to the information extraction task;
a first determining module 906, configured to: determine, based on the initial prompt information and an extraction result of a completed information extraction sub-task in the at least two information extraction sub-tasks, current prompt information corresponding to a current information extraction sub-task;
a first input module 908, configured to: input the text to be extracted and the current prompt information into an information extraction model to determine an extraction result corresponding to the current information extraction sub-task; and
a second determining module 910, configured to determine a target extraction result of the information extraction task based on extraction results corresponding to the at least two information extraction sub-tasks.

Optionally, the information extraction model includes a feature extraction layer, an attention layer, and an output layer, and the feature extraction layer includes a first feature extraction layer, a second feature extraction layer and the first feature extraction layer is coupled with the second feature extraction layer. The first input module 908 is further configured to: input the text to be extracted into the first feature extraction layer, to obtain a text feature of the text to be extracted; input the current prompt information into the second feature extraction layer, to obtain a prompt feature of the current prompt information; input the text feature and the prompt feature into the attention layer, to obtain an attention feature; and input the attention feature to the output layer, to obtain the extraction result corresponding to the current information extraction sub-task.

Optionally, the first input module 908 is further configured to: when the text feature of the text to be extracted is not buffered in the information extraction model, input the text to be extracted into the first feature extraction layer, to obtain the text feature of the text to be extracted, and buffer the text feature in the information extraction model; and when the text feature of the text to be extracted is buffered in the information extraction model, obtain the text feature buffered in advance.

Optionally, the first input module 908 is further configured to: input the attention feature to the output layer to determine a start pointer sequence and an end pointer sequence; and extract, from the text to be extracted, and outputting the extraction result corresponding to the current information extraction sub-task based on the start pointer sequence and the end pointer sequence.

Optionally, the apparatus further includes: a fourth determining module, configured to: when the information extraction task does not include an information extraction sub-task, input the text to be extracted and the initial prompt information into the information extraction model to determine the target extraction result of the information extraction task.

Optionally, the first parsing module 904 is further configured to: identify a type of the information extraction task to determine at least one task type corresponding to the information extraction task; obtain an information extraction object corresponding to each task type; and determine, based on the initial prompt information and the information extraction object corresponding to each task type, the at least two information extraction sub-tasks corresponding to the information extraction task.

Optionally, the apparatus further includes: a searching module, configured to: search for an extraction result corresponding to each information extraction sub-task, to obtain a search result; and determine, based on the search result, whether there is the completed information extraction sub-task.

Optionally, the first determining module 906 is further configured to: when there is no completed information extraction sub-task in the at least two information extraction sub-tasks, determine the initial prompt information as the current prompt information corresponding to the current information extraction sub-task; or when there is the completed information extraction sub-task in the at least two information extraction sub-tasks, determine, based on the initial prompt information and the extraction result of the completed information extraction sub-task, the current prompt information corresponding to the current information extraction sub-task.

Optionally, the at least two information extraction sub-tasks include a first information extraction sub-task; the first determining module 906 is further configured to determine the initial prompt information as first prompt information corresponding to the first information extraction sub-task; and the first input module 908 is further configured to: input the text to be extracted and the first prompt information into the information extraction model to determine a first extraction result of the first information extraction sub-task.

Optionally, the at least two information extraction sub-tasks further include a second information extraction sub-task; and the apparatus further includes: an obtaining module, configured to: determine the first extraction result as the extraction result of the completed information extraction sub-task, determine the second information extraction sub-task as the current information extraction sub-task, return to perform the step of determining, based on the initial prompt information and the extraction result of the completed information extraction sub-task in the at least two information extraction sub-tasks, the current prompt information corresponding to the current information extraction sub-task, until there is no current information extraction sub-task to obtain the extraction results corresponding to the at least two information extraction sub-tasks.

Optionally, the apparatus further includes: an information extraction model training module, configured to: obtain a sample set, where the sample set includes multiple sample texts, and each sample text carries an information extraction label and sample prompt information; extract a first sample text from the multiple sample texts, where the first sample text is any one of the multiple sample texts; input the first sample text and first sample prompt information carried in the first sample into an initial information extraction model, to obtain a first predicted extraction result corresponding to the first sample text; compare the first predicted extraction result with a first information extraction label carried in the first sample text to calculate a loss value; and adjust model parameters of the initial information extraction model based on the loss value, and return to perform the step of extracting the first sample text from the multiple sample texts until a preset stop condition is satisfied, to obtain an information extraction model.

Through applying the solution in the embodiments of the present disclosure, by parsing the information extraction task, a complex information extraction task is converted into at least two simple information extraction sub-tasks, so that this solution can support an information extraction task of any information extraction sub-task combination, thereby improving universality of information extraction. In addition, the extraction results of the at least two information extraction sub-tasks are determined by using the information extraction model, so that a plurality of information extraction sub-tasks are completed by using one information extraction model, thereby improving information extraction efficiency.

The above is a schematic solution of an information extraction apparatus of the embodiments. It should be noted that the technical solution of the information extraction apparatus and the technical solution of the foregoing information extraction method belong to the same concept. For details not described in detail in the technical solution of the information extraction apparatus, refer to the descriptions of the technical solution of the foregoing information extraction method.

Corresponding to the foregoing method embodiment, the present disclosure further provides some embodiments of a conference opinion extraction apparatus. FIG. 10 is a structural schematic diagram of a conference opinion extraction apparatus according to some embodiments of the present disclosure. As shown in FIG. 10, the apparatus includes:
a second receiving module 1002, configured to receive an opinion extraction task, where the opinion extraction task includes a conference text to be extracted and initial prompt information;
a second parsing module 1004, configured to: parse the opinion extraction task to determine at least two opinion extraction sub-tasks corresponding to the opinion extraction task;
a second determining module 1006, configured to determine, based on the initial prompt information and an extraction result of a completed opinion extraction sub-task, current prompt information corresponding to a current opinion extraction sub-task;
a second input module 1008, configured to: input the conference text to be extracted and the current prompt information into an information extraction model to determine an extraction result corresponding to the current opinion extraction sub-task; and
a third determining module 1010, configured to determine a target extraction result of the opinion extraction task based on extraction results corresponding to the opinion extraction sub-tasks.

Through applying the solution in the embodiments of the present disclosure, by parsing the opinion extraction task, a complex opinion extraction task is converted into at least two simple opinion extraction sub-tasks, so that this solution can support an opinion extraction task of any opinion extraction sub-task combination, thereby improving universality of opinion extraction. In addition, the extraction results of the opinion extraction sub-tasks are determined by using the information extraction model, so that multiple opinion extraction sub-tasks are completed by using one information extraction model, thereby improving conference opinion extraction efficiency.

The above is a schematic solution of a conference opinion extraction apparatus of the embodiments. It should be noted that the technical solution of the conference opinion extraction apparatus and the technical solution of the foregoing conference opinion extraction method belong to the same concept. For details not described in detail in the technical solution of the conference opinion extraction apparatus, refer to the descriptions of the technical solution of the foregoing conference opinion extraction method.

Corresponding to the foregoing method embodiment, the present disclosure further provides some embodiments of an information extraction model training apparatus. FIG. 11 is a structural schematic diagram of an information extraction model training apparatus according to some embodiments of the present disclosure. As shown in FIG. 11, the apparatus is applied to a cloud side device, and includes:
an obtaining module 1102, configured to obtain a sample set, where the sample set includes multiple sample texts, and each sample text carries an information extraction label and sample prompt information;
an extraction module 1104, configured to extract a first sample text from the multiple sample texts, where the first sample text is any one of the plurality of sample texts;
a third input module 1106, configured to input the first sample text and first sample prompt information carried in the first sample text into an initial information extraction model, to obtain a first predicted extraction result corresponding to the first sample text;
a calculation module 1108, configured to: compare the first predicted extraction result with a first information extraction label carried in the first sample text to calculate a loss value;
an adjustment module 1110, configured to: adjust model parameters of the initial information extraction model based on the loss value, and return to perform the step of extracting the first sample text from the multiple sample texts until a preset stop condition is satisfied, to obtain model parameters of an information extraction model; and
a first sending module 1112, configured to send the model parameters of the information extraction model to a terminal side device.

Through applying the solution in the embodiments of the present disclosure, the loss value is obtained through calculation based on the first predicted extraction result and the first information extraction label carried in the first sample text, the loss value is compared with the preset stop condition, and the initial information extraction model continues to be trained when the preset stop condition is not satisfied, until the preset stop condition is satisfied, to complete training and obtain the information extraction model. The model parameters of the initial information extraction model are continuously adjusted, so that the finally obtained information extraction model can be more accurate.

The above is a schematic solution of an information extraction model training apparatus of the embodiments. It should be noted that the technical solution of the information extraction model training apparatus and the technical solution of the foregoing information extraction model training method belong to the same concept. For details not described in detail in the technical solution of the information extraction model training apparatus, refer to the descriptions of the technical solution of the foregoing information extraction model training method.

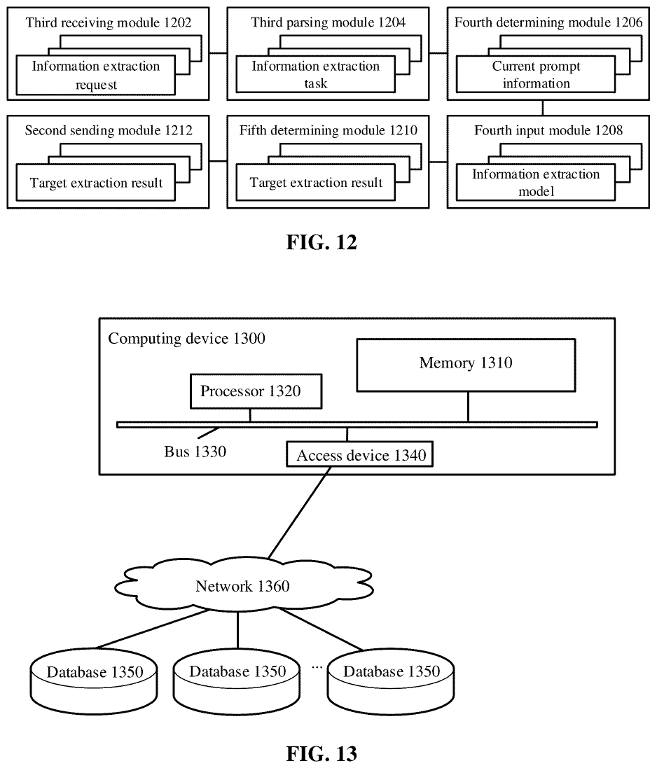

Corresponding to the foregoing method embodiment, the present disclosure further provides some embodiments of an information extraction apparatus. FIG. 12 is a structural schematic diagram of another information extraction apparatus according to some embodiments of the present disclosure. As shown in FIG. 12, the apparatus includes:
a third receiving module 1202, configured to receive an information extraction request sent by a user, where the information extraction request includes an information extraction task, and the information extraction task includes a text to be extracted and initial prompt information;
a third parsing module 1204, configured to: parse the information extraction task to determine at least two information extraction sub-tasks corresponding to the information extraction task;
a fourth determining module 1206, configured to: determine, based on the initial prompt information and an extraction result of a completed information extraction sub-task in the at least two information extraction sub-tasks, current prompt information corresponding to a current information extraction sub-task;
a fourth input module 1208, configured to: input the text to be extracted and the current prompt information into an information extraction model to determine an extraction result corresponding to the current information extraction sub-task;
a fifth determining module 1210, configured to determine a target extraction result of the information extraction task based on extraction results corresponding to the at least two information extraction sub-tasks; and
a second sending module 1212, configured to send the target extraction result of the information extraction task to the user.

Through applying the solution in the embodiments of the present disclosure, by parsing the information extraction task, a complex information extraction task is converted into at least two simple information extraction sub-tasks, so that this solution can support an information extraction task of any information extraction sub-task combination, thereby improving universality of information extraction. In addition, the extraction results of the at least two information extraction sub-tasks are determined by using the information extraction model, so that a plurality of information extraction sub-tasks are completed by using one information extraction model, thereby improving information extraction efficiency. The target extraction result of the information extraction task is sent to the user, thereby improving user experience.

The above is a schematic solution of an information extraction apparatus of the embodiments. It should be noted that the technical solution of the information extraction apparatus and the technical solution of the foregoing information extraction method belong to the same concept. For details not described in detail in the technical solution of the information extraction apparatus, refer to the descriptions of the technical solution of the foregoing information extraction method.

FIG. 13 is a structural schematic block diagram of a computing device according to some embodiments of the present disclosure. Components of the computing device 1300 include, but are not limited to, a memory 1310 and a processor 1320. The processor 1320 is connected with the memory 1310 through a bus 1330, and a database 1350 is configured to store data.

The computing device 1300 further includes an access device 1340. The access device 1340 enables the computing device 1300 to perform communication through at least one network 1360. Examples of these networks include a public switched telephone network (PSTN), a local area network (LAN), a wide area network (WAN), a personal area network (PAN), or a combination of communication networks such as the Internet. The access device 1340 may include at least one of any type of wired or wireless network interface (for example, a network interface controller (NIC)), such as an IEEE 802.11 wireless local area network (WLAN) wireless interface, a world interoperability for microwave access (Wi-MAX) interface, an Ethernet interface, a universal serial bus (USB) interface, a cellular network interface, a Bluetooth interface, and a near field communication (NFC) interface.

In some embodiments of the present disclosure, the components of the computing device 1300 and other components not shown in FIG. 13 may also be connected with each other, for example, through a bus. It should be understood that the structural block diagram of the computing device shown in FIG. 13 is for the purpose of illustration, and is not intended to limit the scope of the present disclosure. A person having ordinary skill in the art may add or replace the other components as needed.

The computing device 1300 is any type of static or mobile computing device, including a mobile computer or a mobile computing device (for example, a tablet computer, a personal digital assistant, a laptop computer, a notebook computer, or a netbook), a mobile phone (for example, a smartphone), a wearable computing device (for example, a smart watch or smart glasses), or another type of mobile device, or a static computing device such as a desktop computer or a personal computer (PC). The computing device 1300 may alternatively be a mobile or static server.

The processor 1320 is configured to execute the following computer-executable instructions. When the computer-executable instructions are executed by the processor, steps of the foregoing information extraction method, conference opinion extraction method, or information extraction model training method are implemented.

The above is a schematic solution of a computing device of the embodiments. It should be noted that the technical solution of the computing device and the technical solution of the foregoing information extraction method, conference opinion extraction method, and information extraction model training method belong to the same concept. For details not described in detail in the technical solution of the computing device, refer to the descriptions of the technical solution of the foregoing information extraction method, conference opinion extraction method, and information extraction model training method.

Some embodiments of the present disclosure further provide a computer-readable storage medium, storing computer-executable instructions. The computer-executable instructions, when executed by a processor, implement steps of the foregoing information extraction method, conference opinion extraction method, and information extraction model training method.

The above is a schematic solution of a computer-readable storage medium of the embodiments. It should be noted that the technical solution of the storage medium and the technical solution of the foregoing information extraction method, conference opinion extraction method, and information extraction model training method belong to the same concept. For details not described in detail in the technical solution of the storage medium, refer to the descriptions of the technical solution of the foregoing information extraction method, conference opinion extraction method, and information extraction model training method.

Some embodiments of the present disclosure further provide a computer program. When the computer program is executed in a computer, the computer is enabled to perform steps of the foregoing information extraction method, conference opinion extraction method, and information extraction model training method.

The above is a schematic solution of a computer program of the embodiments. It should be noted that the technical solution of the computer program and the technical solution of the foregoing information extraction method, conference opinion extraction method, and information extraction model training method belong to the same concept. For details not described in detail in the technical solution of the computer program, refer to the descriptions of the technical solution of the foregoing information extraction method, conference opinion extraction method, and information extraction model training method.

Particular embodiments of the present disclosure are described above. Other embodiments fall within the scope of the appended claims. In some cases, the actions or steps recorded in the claims are performed in sequences different from those in the embodiments and an expected result may still be achieved. In addition, the processes depicted in the accompanying drawings are not necessarily performed in a specific order or successively to achieve an expected result. In some implementations, multitasking and parallel processing are feasible or beneficial.

Computer instructions include computer program code. The computer program code is in a form of source code, object code, and an executable file, some intermediate forms, or the like. A computer-readable medium may include: any entity or apparatus capable of carrying the computer program code, a recording medium, a USB flash drive, a removable hard disk, a magnetic disk, an optical disc, a read-only memory (ROM), a random access memory (RAM), an electric carrier signal, a telecommunication signal and a software distribution medium, and the like.

It should be noted that for each of the foregoing method embodiments, for ease of description, the method embodiment is described as a series of action combinations, but a person having ordinary skill in the art should learn that the embodiments of the present disclosure is not limited to an order of described actions, because according to the embodiments of the present disclosure, some steps are performed in another order or at the same time. A person having ordinary skill in the art should also be aware that the embodiments described in the specification are preferred embodiments, and that the actions and modules involved are not necessarily required for the embodiments of the present disclosure.

In the foregoing embodiments, the descriptions of each embodiment have different focuses, and for a part that is not described in detail in some embodiments, refer to the relevant description of other embodiments.

The exemplary embodiments of the present disclosure disclosed above are used for assisting in elaboration of the present disclosure. Optional embodiments do not provide exhaustive descriptions of all details and do not limit the present invention to the specific implementations described. Apparently, many modifications and changes are made according to content of the embodiments of the present disclosure. These embodiments are selected and specifically described in the present disclosure to better explain the principles and practical applications of the embodiments of the present disclosure, so that a person having ordinary skill in the art can better understand and make good use of the present disclosure. The present disclosure is limited by the claims and the full scope and equivalents thereof.

### Industrial Applicability

The information extraction method, the conference opinion extraction method, and the information extraction model training method provided in the embodiments of the present disclosure are applied to a cloud side device. By parsing an information extraction task, a complex information extraction task is converted into at least two simple information extraction sub-tasks, so that this solution can support an information extraction task of any information extraction sub-task combination, thereby improving universality of information extraction. In addition, the extraction results of the at least two information extraction sub-tasks are determined by using the information extraction model, so that multiple information extraction sub-tasks are completed by using one information extraction model, thereby improving information extraction efficiency.

1. An information extraction method, comprising:
receiving an information extraction task, wherein the information extraction task comprises a text to be extracted and initial prompt information;
parsing the information extraction task to determine at least two information extraction sub-tasks corresponding to the information extraction task;
determining, based on the initial prompt information and an extraction result of a completed information extraction sub-task in the at least two information extraction sub-tasks, current prompt information corresponding to a current information extraction sub-task;
inputting the text to be extracted and the current prompt information into an information extraction model to determine an extraction result corresponding to the current information extraction sub-task; and
determining a target extraction result of the information extraction task based on extraction results corresponding to the at least two information extraction sub-tasks.

2. The information extraction method according to claim 1, wherein the information extraction model comprises a feature extraction layer, an attention layer, and an output layer, and the feature extraction layer comprises a first feature extraction layer, a second feature extraction layer and the first feature extraction layer is coupled with the second feature extraction layer; and
inputting the text to be extracted and the current prompt information into the information extraction model to determine the extraction result corresponding to the current information extraction sub-task comprises:
inputting the text to be extracted into the first feature extraction layer, to obtain a text feature of the text to be extracted;
inputting the current prompt information into the second feature extraction layer, to obtain a prompt feature of the current prompt information;
inputting the text feature and the prompt feature into the attention layer, to obtain an attention feature; and
inputting the attention feature to the output layer, to obtain the extraction result corresponding to the current information extraction sub-task.

3. The information extraction method according to claim 2, wherein inputting the text to be extracted into the first feature extraction layer, to obtain the text feature of the text to be extracted comprises:
when the text feature of the text to be extracted is not buffered in the information extraction model, inputting the text to be extracted into the first feature extraction layer, to obtain the text feature of the text to be extracted, and buffering the text feature in the information extraction model; and
when the text feature of the text to be extracted is buffered in the information extraction model, obtaining the text feature buffered in advance.

4. The information extraction method according to claim 3, wherein inputting the attention feature to the output layer, to obtain the extraction result corresponding to the current information extraction sub-task comprises:
inputting the attention feature to the output layer to determine a start pointer sequence and an end pointer sequence; and
extracting, from the text to be extracted, and outputting the extraction result corresponding to the current information extraction sub-task based on the start pointer sequence and the end pointer sequence.

5. The information extraction method according to claim 1, wherein after the parsing the information extraction task, the method further comprises:
when the information extraction task does not comprise an information extraction sub-task, inputting the text to be extracted and the initial prompt information into the information extraction model to determine the target extraction result of the information extraction task.

6. The information extraction method according to claim 1, wherein parsing the information extraction task to determine the at least two information extraction sub-tasks corresponding to the information extraction task comprises:
identifying a type of the information extraction task to determine at least one task type corresponding to the information extraction task;
obtaining an information extraction object corresponding to each task type; and
determining, based on the initial prompt information and the information extraction object corresponding to each task type, the at least two information extraction sub-tasks corresponding to the information extraction task.

7. The information extraction method according to claim 1, wherein before the determining, based on the initial prompt information and the extraction result of the completed information extraction sub-task in the at least two information extraction sub-tasks, the current prompt information corresponding to the current information extraction sub-task, the method further comprises:
searching for an extraction result corresponding to each information extraction sub-task, to obtain a search result; and
determining, based on the search result, whether there is the completed information extraction sub-task.

8. The information extraction method according to claim 1, wherein determining, based on the initial prompt information and the extraction result of the completed information extraction sub-task in the at least two information extraction sub-tasks, the current prompt information corresponding to the current information extraction sub-task comprises:
when there is no completed information extraction sub-task in the at least two information extraction sub-tasks, determining the initial prompt information as the current prompt information corresponding to the current information extraction sub-task; or
when there is the completed information extraction sub-task in the at least two information extraction sub-tasks, determining, based on the initial prompt information and the extraction result of the completed information extraction sub-task, the current prompt information corresponding to the current information extraction sub-task.

9. The information extraction method according to claim 1, wherein the at least two information extraction sub-tasks comprise a first information extraction sub-task;
determining, based on the initial prompt information and the extraction result of the completed information extraction sub-task in the at least two information extraction sub-tasks, the current prompt information corresponding to the current information extraction sub-task comprises:
determining the initial prompt information as first prompt information corresponding to the first information extraction sub-task; and
inputting the text to be extracted and the current prompt information into the information extraction model to determine the extraction result corresponding to the current information extraction sub-task comprises:
inputting the text to be extracted and the first prompt information into the information extraction model to determine the first extraction result of the first information extraction sub-task.

10. The information extraction method according to claim 9, wherein the at least two information extraction sub-tasks further comprise a second information extraction sub-task; and
after inputting the text to be extracted and the first prompt information into the information extraction model to determine the first extraction result of the first information extraction sub-task, the method further comprises:
determining the first extraction result as the extraction result of the completed information extraction sub-task, determining the second information extraction sub-task as the current information extraction sub-task, returning to perform the step of determining, based on the initial prompt information and the extraction result of the completed information extraction sub-task in the at least two information extraction sub-tasks, the current prompt information corresponding to the current information extraction sub-task, until there is no current information extraction sub-task to obtain the extraction results corresponding to the at least two information extraction sub-tasks.

11. The information extraction method according to claim 1, wherein a training method of the information extraction model comprises:
obtaining a sample set, wherein the sample set comprises a plurality of sample texts, and each sample text carries an information extraction label and sample prompt information;
extracting a first sample text from the plurality of sample texts, wherein the first sample text is any one of the plurality of sample texts;
inputting the first sample text and first sample prompt information carried in the first sample into an initial information extraction model, to obtain a first predicted extraction result corresponding to the first sample text;
comparing the first predicted extraction result with the first information extraction label carried in the first sample text to calculate a loss value; and
adjusting model parameters of the initial information extraction model based on the loss value, and returning to perform the step of extracting the first sample text from the plurality of sample texts until a preset stop condition is satisfied, to obtain the information extraction model.

12. A conference opinion extraction method, comprising:
receiving an opinion extraction task, wherein the opinion extraction task comprises a conference text to be extracted and initial prompt information;
parsing the opinion extraction task to determine at least two opinion extraction sub-tasks corresponding to the opinion extraction task;
determining, based on the initial prompt information and an extraction result of a completed opinion extraction sub-task, current prompt information corresponding to a current opinion extraction sub-task;
inputting the conference text to be extracted and the current prompt information into an information extraction model to determine an extraction result corresponding to the current opinion extraction sub-task; and
determining a target extraction result of the opinion extraction task based on extraction results corresponding to the opinion extraction sub-tasks.

13. (canceled)

14. (canceled)

15. A computing device, comprising:
a memory and a processor;
wherein the memory is configured to store computer-executable instructions, the processor is configured to execute the computer-executable instructions, and when being executed by the processor, the computer-executable instructions implement the following steps:
receiving an information extraction task, wherein the information extraction task comprises a text to be extracted and initial prompt information;
parsing the information extraction task to determine at least two information extraction sub-tasks corresponding to the information extraction task;
determining, based on the initial prompt information and an extraction result of a completed information extraction sub-task in the at least two information extraction sub-tasks, current prompt information corresponding to a current information extraction sub-task;
inputting the text to be extracted and the current prompt information into an information extraction model to determine an extraction result corresponding to the current information extraction sub-task; and
determining a target extraction result of the information extraction task based on extraction results corresponding to the at least two information extraction sub-tasks.

16. (canceled)

17. The information extraction method according to claim 1, wherein the information extraction task refers to a task of extracting information from the text to be extracted.

18. The information extraction method according to claim 1, wherein the initial prompt information is information set to guide an information extraction process.

19. The information extraction method according to claim 1, wherein parsing the information extraction task to determine at least two information extraction sub-tasks corresponding to the information extraction task comprises:
parsing the information extraction task to determine target information of the information extraction task;
determining at least two information extraction sub-tasks corresponding to the information extraction task based on the target information.

20. The information extraction method according to claim 6, wherein obtaining the information extraction object corresponding to each task type comprises:
obtaining the information extraction object corresponding to each task type from a preset object library.

21. The information extraction method according to claim 1, wherein the completed information extraction sub-task refers to a sub-task that is in the at least two information extraction sub-tasks and for which an extraction result has been obtained.

22. The information extraction method according to claim 1, wherein the current information extraction sub-task refers to an information extraction sub-task, in a current information extraction process, for which information extraction is to be performed but an extraction result is not obtained.

23. The information extraction method according to claim 1, wherein the extraction result corresponding to the current information extraction sub-task is a text segment corresponding to the current information extraction sub-task in the text to be extracted.
